(19) United States
(12) Patent Application Publication
(10) Pub. No.: US 2004/0006697 A1
(43) Pub. Date: Jan. 8, 2004

(54) Authentication method and authentication system

(76) Inventors: Hideo Noyama, Yokohama (JP); Takeshi Matsuki, Musashino (JP); Shigeru Matsuzawa, Machida (JP); Shuji Terada, Kawasaki (JP)

Correspondence Address: Antonelli, Terry, Stout & Kraus, LLP, Suite 1800, 1300 North Seventeenth Street, Arlington, VA, 22209, US

(21) Appl. No.: 10/382,860

(22) Filed: Mar. 7, 2003

(30) Foreign Application Priority Data
Jul. 7, 2002 (JP) 2002-293152

(51) Int. Cl. H04L 9/00

(52) U.S. Cl. 713/182

(57) ABSTRACT

In order to suitably and flexibly provide an authentication method suited to an attendant/user and situation of entrance/use, an authentication method in an authentication system for judging propriety of an attendance into a given space makes use of identification information which is issued to a person having authority to grant entrance into the space. The authentication system receives from the manager of the space identification/authentication information issued to the manager of the space, stores the identification/authentication information in a storage unit, receives the identification information from a person seeking attendance in the space, judges whether identification/authentication information corresponding to the identification information is stored in the storage unit, and judges propriety of the person seeking attendance using identification/authentication information stored in the storage unit and the identification information in the case where identification/authentication information stored in the storage unit is present.

### BACKGROUND OF THE INVENTION

The invention relates to a method and a system for authentication, and more particularly, to an authentication technique capable of suitably controlling entrance to and exit from a given space, and an entrance/exit control technique making use of the same.

Generally, systems for control of entrance to and use of various facilities include a method of judging whether entrance is authorized by confirming propriety of data stored in the ticket, IC card, or the like owned by the entrant, a method of judging whether entrance is authorized on the basis of agreement between personal identification data stored in an IC card, or the like with data which are beforehand organized in a database or the like. In the case where control of entrance to and use of various facilities is performed with an IC card, or the like, a person scheduled for entrance/use beforehand gets authority for entrance into various facilities through a ticket or the like from a person who manages the entrance management system for the various facilities, and information is registered in a database of the entrance management system to identify the person having authority for entrance. Then, the entrance/use authorization information stored at the point of time when authority for entrance was given in the IC card or the like is checked when the card is brought by the person at the time of entrance/use, whereby the propriety of the user is verified and entrance is permitted. In such case, the person who manages the entrance control system is the one who gives authority for entrance into various facilities to a person scheduled for entrance/use through a ticket or the like, registers information in a database, and unitarily manages entrance/use of various facilities, and a person who directly or indirectly gets authority for entrance/use from the person who manages the entrance control system is subject only to control by the person who manages the entrance management system and gives authority for entrance (owner of the facilities, or the like). An example thereof is disclosed in JP-A-110923/1996 (Patent Document 1).

### SUMMARY OF THE INVENTION

With the above prior techniques, however, where the owner or manager of a facility provides or entrusts management of a given space to another person, the person now given use or management of the space cannot according the power to grant entrance/use within his/her own authority flexibly control entrance/use of still another person. That is, since the person who alone sets up and manages the conditions for entrance to and use of the space and so owns the entrance management system directly or indirectly gives authority for entrance/use, a person who does not manage the entrance control system and to whom a space is only presented or to whom authority for management is transferred cannot arbitrarily set entrance/use conditions on each occasion upon his/her own authority and can only give authorization data to another person which fulfills those predetermined conditions of authority for entrance given to him and which can be identified by the entrance management system.

For example, in the case where a person making a reservation (reservation maker) for a common meeting room made available by the owner of the room, has another person (attendee of a meeting) attending a meeting held in the meeting room, the reservation maker given only authority for his/her own entrance, such as a key or password, must either come earlier than the other attendees to unlock the room, or give the key, or password itself to another attendee of the meeting. It may not be necessary for the reservation maker to come earlier, depending upon the contents of the meeting. It is troublesome to select on each occasion whether the given authority for entrance should be given to an attendee of the meeting who is not the reservation maker and is expected to come early, but there can be on the contrary a problem in security when a common authority for entrance (unlocking key) is given to all attendees of the meeting. In this manner, it is not possible to flexibly control entrance/use of attendees of the meeting in accordance with the reservation maker's intent and the situation.

Hereupon, the invention includes a configuration, in which authentication is executed in a manner suited to the attendant/user and situation of entrance/use. Also, the invention includes an entrance control technique, with which a person to whom a space has been entrusted controls persons' entrance into a given space.

Further, the invention includes an entrance/exit control technique, with which a person reserving a common meeting room controls attendees of a meeting in entering or exit the common meeting room.

In order to solve the above problem, the invention has a feature in judging with an authentication system or an entrance/exit control system whether a person may properly enter or use a space using information issued that person having authority for entrance/use of the space and also different information issued to the manager or maker of a reservation for the space. Here, the space may be any of a variety of facilities, such as a meeting room, hall, building, or the like. Information issued to a person having authority for entrance into the space (attendant, user, or the like) includes identification information (including user ID, password) or as ticket data stored in an IC card, portable telephone, or the like. Such identification information may be issued at the time of every application for use of a space, or that information, which is beforehand issued and kept in the user's IC card, portable telephone, or the like, may be registered in a database or the like in the authentication system or entrance/exit control system with every application for use. Information issued to a manager, reservation maker, or the like of a space includes information to be issued to a person having authority for entrance which has been encoded with a predetermined encryption algorithm, or provided in form of complex binary data or the like, so that security is enhanced for the whole system. Authority to enter is verified using the information issued to a person having authority for entrance and information issued to a manager or a person reserving a space whereby the manager or person reserving the space adjusts the expiration date of information owned by him or the time at which the information is forwarded to the authentication system, to enable adjustment of the process of authentication in the authentication system. Also, since information owned by plural persons is used in checking an attendant/user, it is easy to prevent that leakage of important data in space management, which is caused by issuance of authority for entrance, such as a key, password, or the like. By suitably changing the way to combine information owned by plural persons, there is further effect.

More concretely, there is provided an authentication method in an authentication system, for verifying authority to enter into and use a given space based on identification information (data) which had been issued to a person having authority for entrance/user of the space. The authentication system receives information (data) for authentication of identification information issued to a manager of the space or person reserving the space, in response to an application of the manager or the reservation maker, stores this identification/authentication information in storage means, receives the identification information from the present attendant/user, judges whether there is identification information corresponding to this identification information received from the present attendant/user stored in the storage means, and if there is such information verifies propriety of the attendant/user using this identification information stored in the storage means and the identification information received from the attendant/user.

Also, the invention provides an entrance management method making use of a meeting room reservation system which receives booking for use of a meeting room and a meeting room security system which controls use of the meeting room, the meeting room security system using a secret key to cryptograph information specifying a meeting to create a first cryptograph value, creating a second cryptograph value in connection with a user ID, allotting the first cryptograph value to attendees of the meeting, and forwarding the second cryptograph value to the person reserving the meeting room. The meeting room security system uses the second cryptograph value which is provided by the person reserving the meeting room, the user ID which is received from an attendee of the meeting, and a public key corresponding to the secret key to confirm propriety of the attendee of the meeting and properly permit entrance.

In addition, the invention includes programs which realize the above function and a recording medium in which the programs are stored. Further, the recording medium includes carrier wave.

### BRIEF DESCRIPTION OF THE DRAWINGS

FIG. 1 is a general, configurational view showing an embodiment of a network environment;

FIG. 2 is a function block diagram showing an embodiment of a main function of an authentication information management system 100;

FIG. 3 is a function block diagram showing an embodiment of a main function of an authentication system 110;

FIG. 4 is a view showing an example of data structure stored in a storage unit 103 of the authentication information management system 100;

FIG. 5 is a view showing an example of data structure stored in a storage unit 113 of the authentication system 110;

FIG. 6 is a view showing the flow of entrance/use authority information (identification information) in the authentication information management system 100, including issuance and monitoring of information;

FIG. 7 is a view showing a flowchart for information for registration of identification/verification information in the authentication system 110;

FIG. 8 is a view showing a flowchart for verification of identification information in the authentication system 110;

FIG. 9 is a view showing an example in which an embodiment is applied to a meeting room reservation system;

FIG. 10 is a view showing an example in which an embodiment is applied to a meeting room security system;

FIG. 11 is a view showing an example, in which a second embodiment is applied to a meeting room reservation system;

FIG. 12 is a view showing an embodiment of multiple value function generating means; and

FIG. 13 is a view showing a further embodiment, in which the invention is applied to a meeting room security system.

### DESCRIPTION OF THE PREFERRED EMBODIMENTS

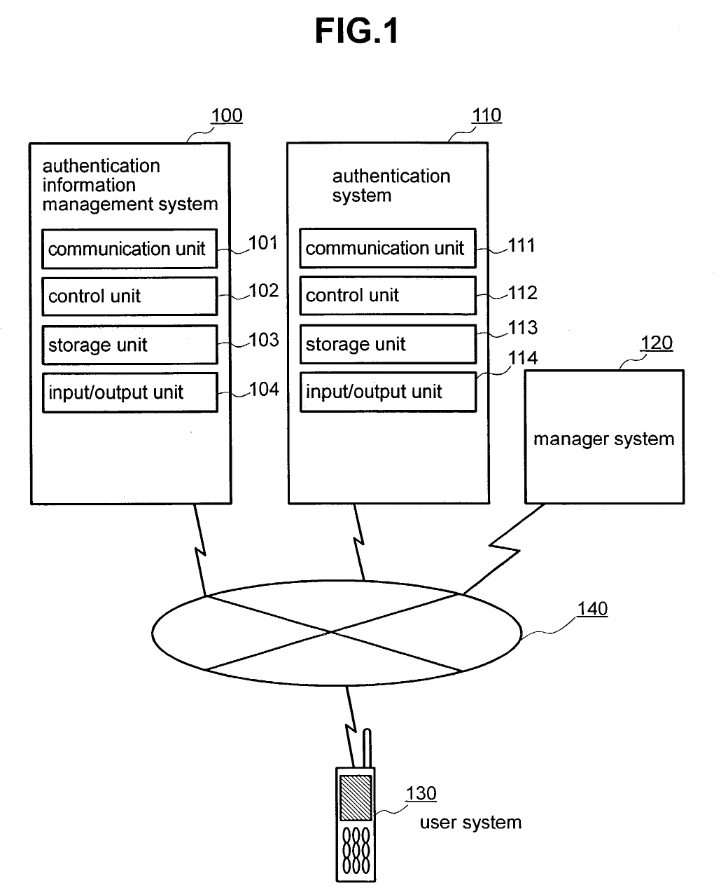

A detailed explanation will be given below to an embodiment of the invention with reference to the drawings. FIG. 1 is a general, configurational view showing an embodiment of a network environment, to which the invention is applied.

In the embodiment, an authentication information management system 100 for making issuance, registration and management of admission/use authority information (identification information) required in use of a given space including various facilities such as meeting rooms, places of meeting, buildings or the like, an authentication system 110 for managing entrance into (exit from) the space, a manager system 120 used by a reservation maker or a manager for managing conditions of entrance/use into the space, and a user system 130 used by users (attendants) of the space are connected together via a network 140 such as Internet, a public network, or an exclusive network. Ways to connect between the respective systems are various, and security can be improved by providing an exclusive network separate from a public network, for example, between the authentication information management system 100 and the authentication system 110 and between these systems and other systems.

The authentication information management system 100 and the authentication system 110 may be a large computer or server system, and comprise a communication unit (101, 111) serving as an interface when communication to the outside is made by way of the network 140, a control unit (102, 112) comprising microchips or the like for performing control of the whole system and the program processing, a storage unit (103, 113) for preserving programs and data, and an input/output unit (104, 114) composed of a display device displaying information, input devices such as a keyboard, mouse, or a card R/W drive. The storage unit (103, 113) comprises a main storage unit such as memory, an auxiliary memory such as a hard disk, a database or the like is constructed, and the storage unit 103 stores data and programs which should be preserved for the processing in the authentication information management system 100 including an encryption program (encryption algorithm), an identification information generation program, and a data management program (identification information management, schedule management, or the like). The storage unit 113 stores data and programs which should be preserved for the processing in the authentication system 110, in addition to a decryption program (decryption algorithm), a data verification (authentication) program, and a data management program (management of authentication/identification information, entrance (exit) management). The function of the authentication information management system 100 and the function of the authentication system 110 may be managed as separate and independent systems or provided as a unified system according to use thereof. Also, a part of these functions of the storage units 103, 113 may be performed by a separate or common database, outside the authentication information management system 100 and the authentication system 110.

The manager system 120 and the user system 130 also comprise a control unit relating to control of the system and the program processing at need, a storage unit, a communication unit for communication via a network such as Internet or the like, display device displaying information, and an input device such as keyboard and mouse with which a manager or user inputs information, and a card R/W by which data on an IC card, magnetic card, or the like are read or written. For example, in the case where the manager system 120 and the user system 130 are portable telephones, they comprise a communication unit serving as an interface for communication provided with an antenna, which performs radio transmission/reception and a dataport which performs transmission/reception of data, an input/output unit composed of a speaker for outputting voice, a display screen for displaying image/character data, a microphone for collecting voice, keys with which character codes are input, a storage unit for storing data, and the like. The manager system 120 and the user system 130 are not to limited to portable telephones but may be portable terminals such as PDA which are connectable to a network such as Internet and personal computers.

An outline of the embodiment will be described with reference to FIG. 1. The person who provides a management system for a given space using the authentication information management system 100 and the authentication system 110, receives through the manager system 120 a request from a person (a person becoming the manager/person in charge during a term of utilization of the space, a reservation maker, or the like) who meets predetermined conditions, and presents a scheme by which this manager/reservation maker can manage the space in a specified location and specified date and hour to this manager/reservation maker on the basis both on the use conditions requested by the manager/reservation maker and the conditions which the person providing the management system for the space set beforehand. Concretely, the authentication information management system 100 having received a request from the manager system 120 generates identification information to identify persons with authority for entrance/use at a specified time of entrance/use, and information used to verify propriety of an attendant/user using the above identification information (identification/authentication information), forwards the identification/authentication information to the manager system 120, and forwards the identification information to the user system 130. The authentication system 110 determines whether entrance/use of the space is authorized using the identification information which the attendant/user brings, and identification/authentication information received from the manager/reservation maker. In the case where either the identification information or the identification/authentication information is absent, and in the case where propriety is denied, propriety of an attendant/user cannot be verified, and in this case the manager/reservation maker controls the time limit for identification/authentication information to be delivered to the authentication system 110 and the expiration date of the identification/authentication information, thereby changing conditions for entrance/use.

In addition, the authentication information management system 100 may use such a structure that after the authentication system 110 stores the generated identification/authentication information in an accessible database and the manager system 120 has accepted use of the identification/authentication information, the authentication system 110 can use the identification/authentication information. The object of the invention is not lost and the proper effect is attained in the case where after the authentication system 110 stores that identification information which is before hand preserved by the user system 130 to identify users in an accessible database and the identification/authentication information is used to confirm the identification information, propriety of an attendant/user possessing the identification information is verified, the user system 130 generates identification/authentication information using that identification information which was beforehand preserved in the user system to identify the above attendants/users, and the authentication system 110 is made able to utilize this identification/authentication information so that verification of an attendant/user having the identification information is made possible.

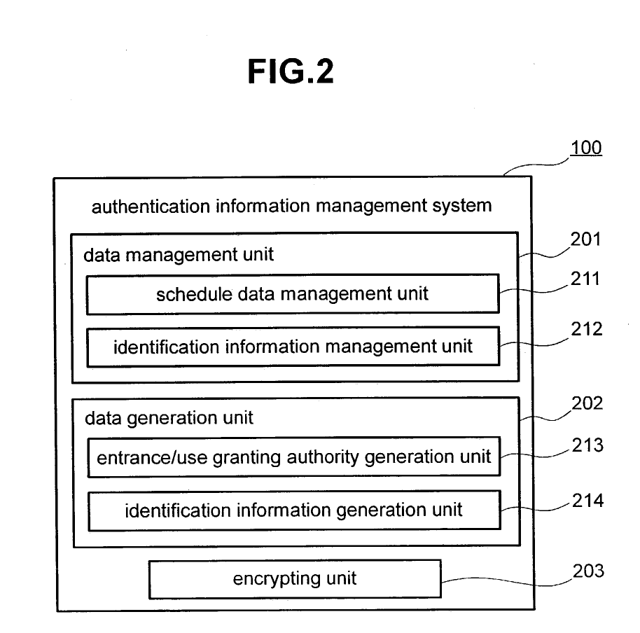

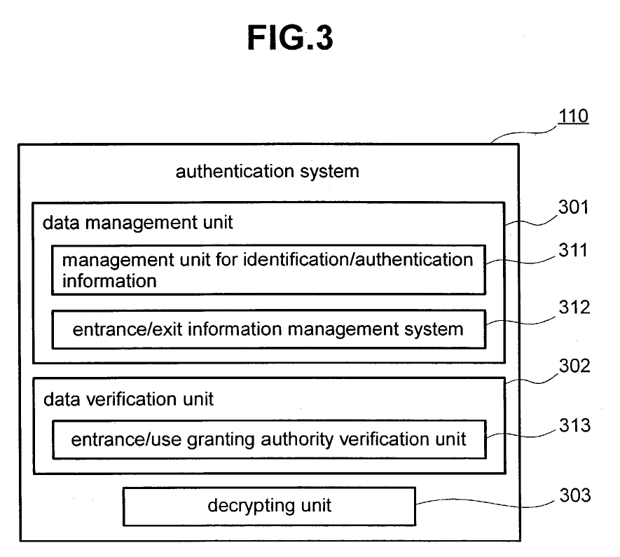

Respective functions of the authentication information management system 100, the authentication system 110, the manager system 120, and the user system 130 can be provided in the form of hardware or software. FIG. 2 shows an embodiment of a main function of the authentication information management system 100, and FIG. 3 shows an embodiment of a main function of the authentication system 110.

FIG. 2 is a block diagram showing the embodiment of the main function of the authentication information management system 100. A program or the like stored in the storage unit 103 and the control unit 102 interlock with each other to realize the functions of respective steps described below. The authentication information management system 100 comprises a data management unit 201 for storing and managing data in the storage unit 103, a data generation unit 202 for generating data, and a cryptographing unit 203 for performing a cryptographing processing based on predetermined data. The data management unit 201 has functions such as a schedule data management unit 211 for managing schedule data relating to use of a given space and reservation status, an identification information management unit 212 for managing identification information. The data generation unit 202 has functions such as an entrance/use authority generation unit 213 for generating original data (unlocking data) giving entrance/use authority of the space and an identification information generation unit 214 for generating information identifying users/attendants of the space. A plurality of the cryptographing units 203 may be provided according to contents (encryption algorithm, or the like) of the cryptographing processing.

FIG. 3 is a block diagram showing the embodiment of the main function of authentication system 110. A program or the like stored in the storage unit 113 and the control unit 112 interlock with each other to realize the function of respective steps described below. The authentication system 110 comprises a data management unit 301 for storing and managing data in the storage unit 113, a data verification unit 302 for performing verification and authentication of data, and a decrypting unit 303 for performing a decrypting processing based on predetermined data. The data management unit 301 has functions such as an identification/authentication information management unit 311 for performing management of identification/authentication information used to verify the identification information brought by an attendant/user, and an entrance/exit information management system 312 for managing entrance/exit information for the space, and the data verification unit 302 has functions such as an entrance/use authority verification unit 313 for performing verification using original data (unlocking data) giving entrance/use authority for verification that other original data (unlocking data) certifies entrande/use authority. A plurality of decrypting units 303 may be provided according to contents (decryption algorithm, or the like) of the decrypting processing.

In addition, changes can be made in the combination of the respective functions shown in FIGS. 2 and 3.

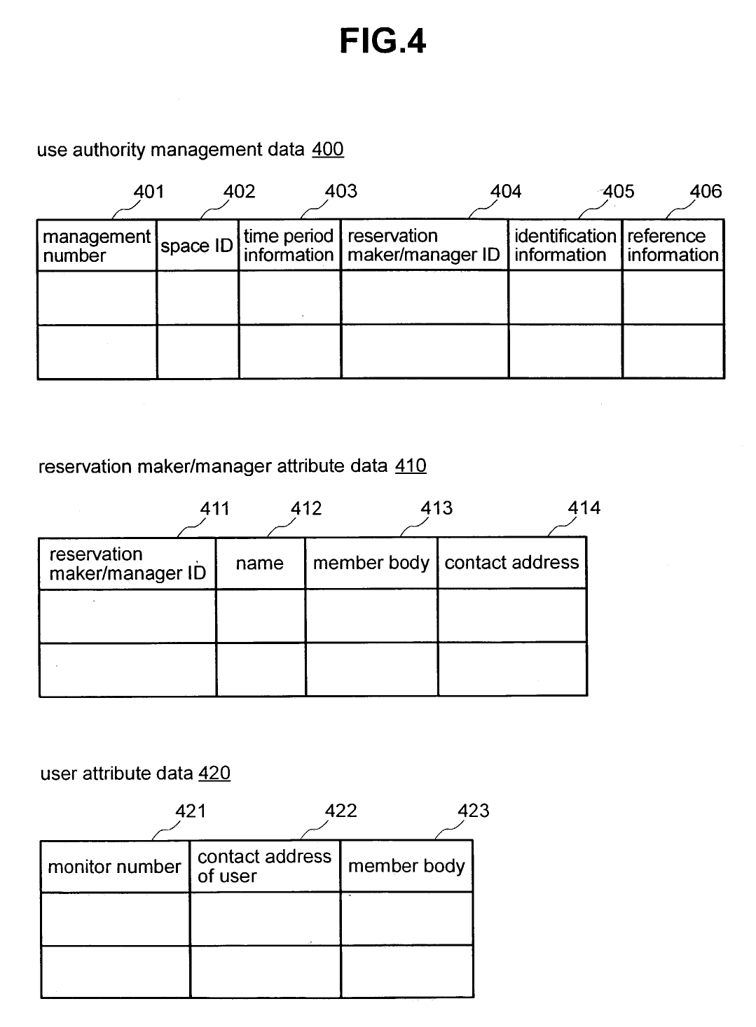

FIG. 4 is a view showing an example of data structure in the storage unit 103 of the authentication information management system 100. The authentication information management system 100 manages entrance/use authorization information (identification information) to be issued and managed at the time of utilization of a given space, such entrance/use authorization management data 400 including reservation/monitor numbers 401, a space ID 402 for specifying the space made available for which the entrance/use authority information has been issued, set time period information 403 specifying time period, date and hour of the space which has been provided, a reservation maker/monitor ID 404 for specifying the manager of/person reserving the space at a specific time, identification information 405 for specifying the user of the presented space, and reference data 406 such as fee. Information regarding the reservation maker/manager, reservation maker/manager attribute data 410, includes the name 412 of a reservation maker/manager, member body 413 such as company and department therein, place of employment, post of employment, or the like, contact address 414 such as residence, telephone number, and e-mail address. This data is connected with the reservation maker/manager ID. User attribute data 420 including the contact address 422 of the user such as e-mail address and the member body 423 such as place of employment are linked with the reservation/monitor number and are managed as the information regarding a user.

In addition, while the use authority management data 400, the reservation maker/manager attribute data 410, and the user attribute data 420 are managed separately in the embodiment, these data may be managed as a series of data and the combination of categories of the data may be appropriately modified.

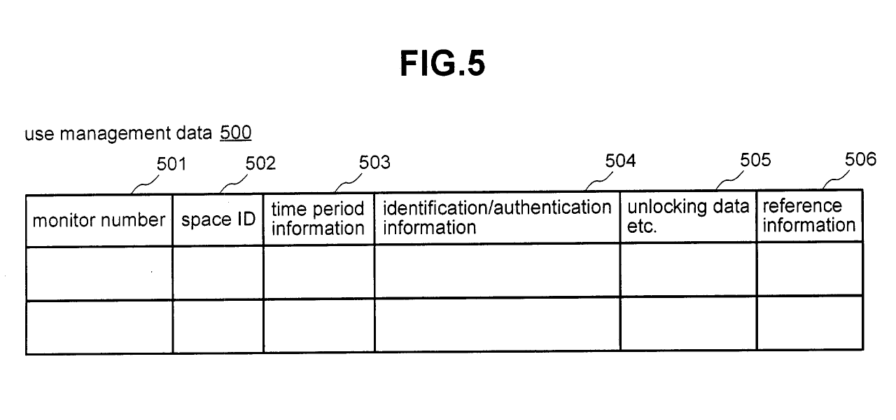

FIG. 5 is a view showing an example of data structure in the storage unit 113 of the authentication system 110. The authentication system 110 use for its management of entrance/exit for a given space use management data 500 including reservation/monitor numbers 501, a space ID 502 for specifying the space for which the entrance/use authority information has been issued, time information 503 for specifying the time period, date and hour made available, information 504 for authentication of identification information, original data 505 such as unlocking data for entrance/use authority, and reference information 506 including a reservation maker/manager ID, expiration date of the identification/authentication information.

Data managed in FIGS. 4 and 5 may be beforehand forwarded to the other party or may be appropriately managed in a common database.

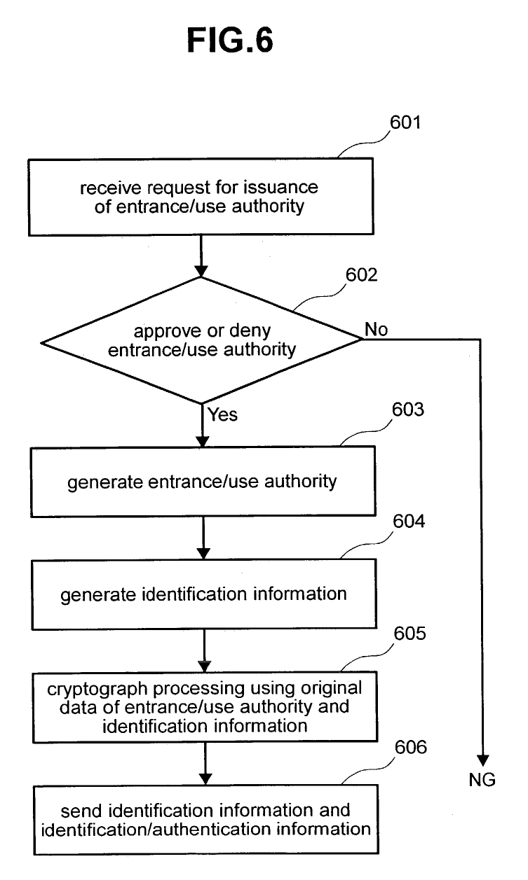

FIG. 6 shows the flow of entrance/use authority information (identification information) as it is issued and organized in the authentication information management system 100.

The authentication information management system 100 receives a request to be given authority to grant entrance/use from a reservation maker/manager via the communication unit 101 (601). At this time if necessary, the space and time for which entrance/use granting authority is desired may be specified, and usage restrictions such as effective period of identification/authorization information and specification of authorization information, described later, may be received, and it may be arranged that information regarding the actual user is received.

The authentication information management system 100 judges whether issuance of entrance/use granting authority is possible or not (602). In the judgment, whether a person who desires entrance/use granting authority has the right to receive services via the applicant's system is confirmed on the basis of information received together with the request for issuance of entrance/use granting authority, and in the case where entrance/use of a space is limited to one at a time, the schedule data management unit 211 confirms whether entrance/use authority of the space has already been issued, on the basis of the use authority management data 400. Entrance/use granting authority of a space can be issued for every space and every use time, in which case the schedule data management unit 211 performs management with the use of a space ID 402 and presented time period information 403. If it is decided that issuance of entrance/use granting authority is impossible, notice is given to that effect, and in the case where such issuance is possible, the following processing is performed, and the data management unit 201 manages reservation/monitor numbers 401, a reservation maker/manager ID 404, and identification information 405 to thereby enable management of entrance/use authority.

The entrance/use granting authority generation unit 213 generates original data, such as unlocking data, which gives entrance/use granting authority (603). At this time, unlocking data set up beforehand may be utilized. However, security for a presented space can be enhanced by generating original data for entrance/use granting authority every request for issuance of entrance/use granting authority. The original data for entrance/use granting authority may be generated in connection with information regarding the reservation maker/manager, the space and the time period. When the original data for entrance/use granting authority includes information on the space and time period, the space and the time period can be again confirmed when the authentication system 110 verifies data for judgement of propriety of an attendant, which can enhance accuracy in verification.

The identification information generation unit 214 generates identification information used for specifying a person to have authority to use the space (604). Such identification information may be generated each occasion or identification information acquired beforehand from that user and beforehand entered in the authentication information management system 100 may be used. In the case where the information is beforehand acquired, labor required in forwarding identification information to a user can be saved.

The cryptographing units 203 perform a cryptographing processing making use of the original data for entrance/use granting authority and identification information (605). The cryptographing processing includes, for example, a method of cryptographing original data for entrance/use granting authority by a predetermined algorithm with the identification information as the cryptographic key data. In this manner, according to the embodiment, leakage of data required for space management can be effectively prevented by performing the arithmetic processing (cryptographing processing) using a predetermined algorithm. An appropriate effect can be produced alternatively by cryptographing the identification information with the original data for entrance/use granting authority as the cryptographic key.

Via the communication unit 101, the identification information is forwarded to the user, and the original data of entrance/use granting authority and cryptograph data generated in the cryptographing processing with the use of the identification information are forwarded to the reservation maker/manager for use as identification/authentication information (606). In the case of direct forwarding to a user, it is feasible to use the authentication information management system 100 for automatic extraction and automatic transmission of data 422 of contact addresses of users, such as e-mail addresses or the like, managed as the user attribute data 420. Services meeting the individual preferences of the reservation maker/manager can be provided by getting information on the users including contact address from the reservation maker/manager with each request by the latter for issuance of entrance/use granting authority, the address to send identification information is determined using this information regarding the users, and identification information is sent to the user through the reservation maker/manager.

Even if telephone and post are used instead of e-mail via the Internet, the method of receiving a request for issuance of entrance/use granting authority and the method of forwarding identification information or identification/authentication information are within the scope of the invention. In the case of forwarding via Internet or the like, high level authentication becomes possible at the time of data verification in the authentication system 110 because an environment capable of making data complex can be provided when identification information and identification/authentication information is sent as electronic data. When identification information is made to be a personalized number of four figures, seven figures, or the like and identification/authentication information is made into complex binary data of several tens of thousand bits, a structure convenient for the attendant/user can be provided while cryptographic protection is kept sufficiently strong. The attendant/user does not need any special additional device for the invention to be utilized.

Also, instead of forwarding identification/authentication information directly to the reservation maker/manager, the authentication system 110 may register the information in an accessible database and merely give notice of such registration to the reservation maker/manager. In this case, the same effect can be produced provided that identification/authentication information is made effectively available in the authentication system 110 after permission for use of the identification/authentication information is given to the reservation maker/manager. Instead of generating identification information in STEP 604, it will do to generate identification/authentication information, cryptograph original data of entrance/use granting authority with the identification/authentication information as the cryptographic key data, and make that cryptographic data which is generated the identification information.

Alternatively, the identification/authentication information need not be sent directly to the reservation maker/manager, but may be registered in a database to which the authentication system 110 has access, after which notice of such registration is sent to the reservation maker/user. In this case, after the reservation maker/manager is approved for use of identification/authorization information, the identification/authorization information is made effectively usable in the authorization system 110 and the same function can be carried out. Instead of generating identification information in step 604, identification/authorization information may be generated, after which the entrance/use granting authority original data is encoded using the identification/authorization information as the encoding key and the thus encoded data is made the identification information.

In addition, charging a fee for every instance of actual entrance/use of the space is made possible by individually managing the identification information generated in the authentication information management system 100, having the authentication system 110 forward identification information which an attendant/user gives to the authentication system 110 at the time of entrance/use, and collating such identification information with the identification information which is stored and arranged. With such structure, a request for a particular number of people to attend/use the space from the operator of the authentication system 110 can be properly evaluated in the case where the authentication information management system 100 and the authentication system 110 are managed under separate organizations.

The present flow can be appropriately modified in sequence; for example, Steps 603, 604 can be reversed.

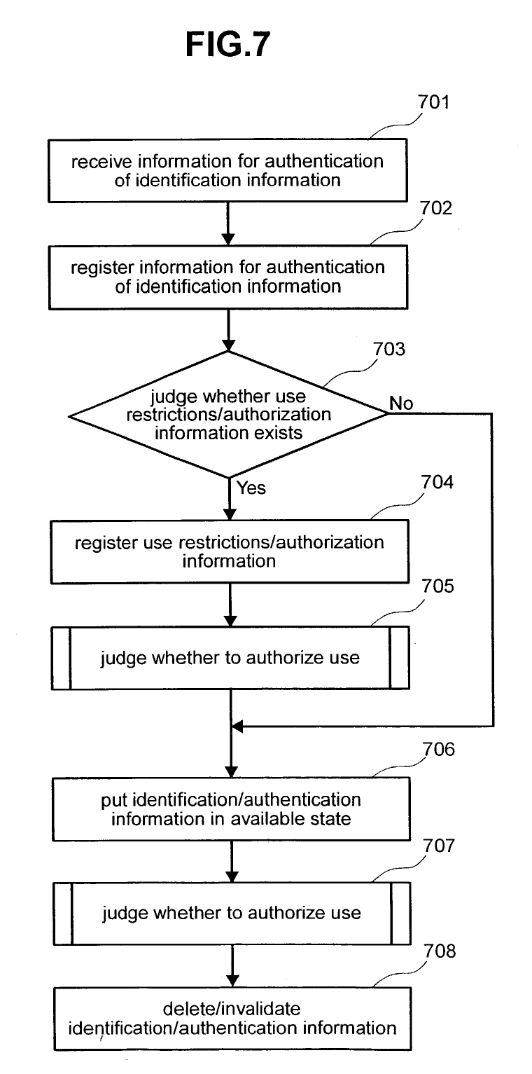

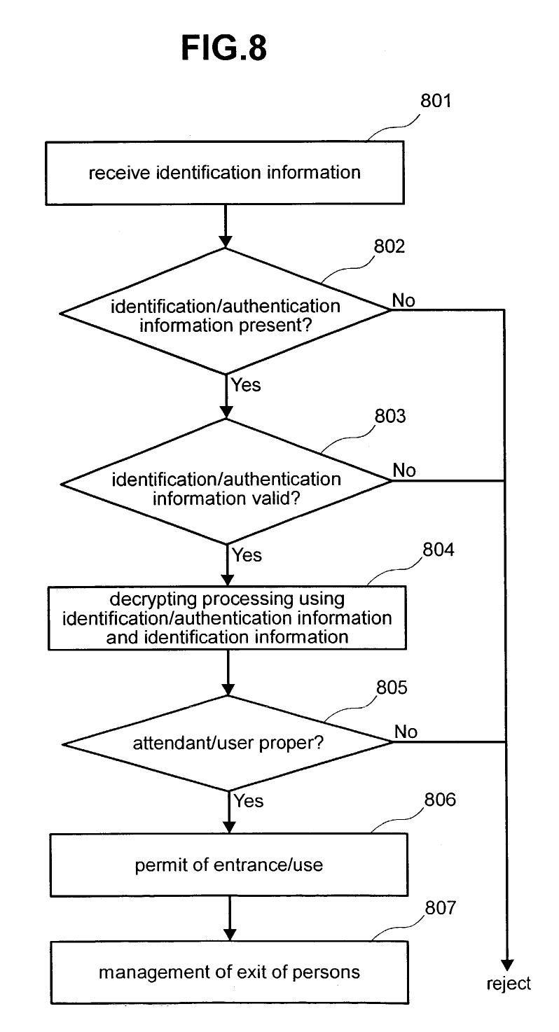

FIGS. 7 and 8 show entrance (exit) management flowcharts in the authentication system 110. FIG. 7 is a flowchart for registration of identification/authentication information in the authentication system 110.

The authentication system 110 receives identification/authentication information from a reservation maker/manager via the communication unit 111 and the input/output unit 114 (701). At this time, designation of use restrictions such as an expiration date of identification/authentication information or authorization information may be received as necessary. The authentication system 110 utilizes the identification/authentication information in accordance with the expiration date or the like, and so the reservation maker/manager can restrict entrance/use without being aware of the timing of forwarding/approval of the identification/authentication information.

The information management unit 311 for authentication of identification information stores identification/authentication information 504 among its use management data 500, which is created on the basis of original data 505 of entrance/use authority such as reservation/monitor numbers 501, a space ID 502, allowed time period information 503, and unlocking data, which are forwarded from the authentication information management system 100 as needed (702). The reservation maker/manager may be specified using, for example, the reservation maker/manager ID which is beforehand forwarded and managed from the authentication information management system 100 and the reservation maker/manager ID which is actually forwarded from the reservation maker/manager. In the case where the authentication system 110 judges propriety of an attendant/user on the basis of agreement of the data which is decrypted by the use of identification information owned by the attendant/user and identification/authentication information with the original data 505 of entrance/use granting authority, there is a need of managing original data of entrance/use granting authority, such as unlocking data or the like, in the use management data 500. In the case where information regarding the space and time period is embedded in the original data of entrance/use grating authority, propriety of an attendant/user can be judged by confirming the match of decrypted data and the actual entrance/use space and time period, so that it is possible to omit the original data 505 of entrance/use granting authority from the use management data 500.

In the case where restrictions are imposed on the process of verification of an attendant/user and approval or denial of entrance depending on the presence or absence of identification/authentication information, registration in the Steps 701, 702 have appropriate effect, but in the case where designation of use restrictions such as an expiration date of identification/authentication information or authorization information is received, the information management unit 311 judges whether use restrictions such as an expiration date of identification/authentication information or authorization information is present (703). In the case where it is found in the above judgment that there is use restrictions such as an expiration date of identification/authentication information or authorization information, contents of the information are registered in reference information 506 of the use management data 500 (704), and managed so that use is impossible (invalid), in accordance with the use restrictions/permission information (705). In the case where use is made possible by a notification of use permission from the reservation maker/manager, the passage of time, or where use restrictions/permission information is absent in STEP 7, identification/authentication information is put in the usable state (706).

It is desired in terms of security in space management that even after being put in the usable (effective) state, the information management unit 311 judges possibility of use according to specified timing and instructions and based on requirements prescribed in use restrictions or authorization information or requirements prescribed in the time period information 503 forwarded from the authentication information management system 100 (707), and deletes or invalidates identification/authentication information in the case where use is not possible (708). Here, the specified timing includes timing of operations confirming validity of identification/authentication information for verification of identification information described later in flowchart FIG. 8.

In addition, appropriate effect is produced even with the technique of providing a flag for judgment of validity of identification/authentication information in place of the use restrictions/authorization information and judging usability (validity) on the basis of presence or absence of the flag.

In the case where identification/authentication information is beforehand provided from the authentication information management system 100, the authentication system 110 makes identification/authentication information usable (valid) according to use authorization forwarded from the reservation maker/manager and use restrictions/authorization information preset through the authentication information management system 100.

FIG. 8 is a flowchart of verification of identification information in the authentication system 110.

The authentication system 110 receives identification information from an attendant/user via the communication unit 111 and the input/output unit 114 (801). While there can be communication via portable terminals such as portable telephones or the like, insertion of an IC card which stores identification information, manual input, or the like, a method of enabling contact only in the vicinity of the space is preferable.

The authentication system 110 confirms identification information via the information management unit 311, verifying whether identification/authentication information corresponding to identification information is set in the use management data 500 (802). At this time, there are a method of retrieving/extracting identification/authentication information using as keys the information regarding space and time period specified in the identification information received from the attendant/user, a method of receiving a reservation/monitor number together with identification information and performing retrieval/extraction with the reservation/monitor number as a key, or the like. In the case where it is judged that corresponding identification/authentication information is not set, propriety of the attendant/user cannot be verified, and so entrance/use is not permitted at that point of time. In the case where corresponding identification/authentication information is set, it is confirmed whether the identification/authentication information is valid (803). In the case of invalidity, propriety of the attendant/user cannot be verified, and so entrance/use is not permitted at that point of time.

Steps 802 and 803 may be combined into one operation judging whether effective identification/authentication information is set. Also, in the case where original data of entrance/use granting authority contains information with respect to the space and time period, an appropriate effect is produced when the following verification processing is performed for all identification/authentication information which is valid when identification information is received.

In the case where valid identification/authentication information is present, verification of identification information using the identification/authentication information is carried out via the entrance/use granting authority verification unit 313. The decrypting unit 303 performs the decrypting processing with an algorithm corresponding to a predetermined decryption algorithm used in the authentication information management system 100 (804), and propriety of the attendant/user is judged/verified on the basis of the decrypted data (805). In the case where original data of entrance/use granting authority is decrypted with identification information as the cryptographic key, the cryptographic data constitute identification/authentication information, so that in the decrypting processing the identification/authentication information is decrypted with identification information as a decryption key (cryptographic key). In the case where original data of entrance/use granting authority is cryptographed with identification/authentication information as a cryptographic key, identification information received from an attendant/user is decrypted with the identification/authentication information as a decryption key. Decrypted data obtained as a result is verified, and it is judged whether the decrypted data agree with original data of entrance/use granting authority which is beforehand set in the authentication system 110, and whether information concerning the space and time period which are contained in the decrypted data agree with information concerning the space and time period in the identification information received from the attendant/user. Also, in the case where identification information is cryptographed with original data of entrance/use granting authority used as the cryptographic key, identification/authentication information (or identification information) decrypted with original data of entrance/use granting authority set beforehand in the authentication system 110 used as the decryption key is compared with identification information (or identification/authentication information) received from the attendant/user. The technique of judging propriety depending upon whether the decrypted data agrees with data, set beforehand in the authentication system 110 can achieve rapid processing, and the technique of confirming consistency of information concerning the space and time period which are contained in the decrypted data, with information concerning the space and time period in the identification information received from an attendant/user, can achieve reliability and safety in processing.

In addition, while an explanation has here been given of the cryptographing processing with a common key system in the embodiment, the invention is not limited thereto but may use a secret key/public key system. In this case, the decrypting processing is performed using key data corresponding to key data used in the cryptographing processing, and, for example, the key data used in the cryptographing processing can be suitably modified into data uniquely corresponding with identification information forwarded to an attendant/user. Also, with the common key system, identification information or the like is not used as a direct cryptographic key but information related to identification information or the like may be used, in which case the information related to identification information is the decryption key.

In the case where an attendant/user is verified, entrance/use is permitted (806), and in the case where an attendant/user is not verified, entrance/use is not permitted.

In the case where entrance/use is permitted, identification information or the like relating to the attendant/user is registered, and by checking the management data 500 through the entrance/exit information management system 312 at the time of exit of the attendant/user, exit management (807) is possible. As described above, fee charging processing may be performed by forwarding identification information received from an attendant to the authentication information management system 100.

The above embodiment is applicable to entrance/exit management of a building, a meeting place, or the like, such that by making a reservation maker/manager a guard who manages entrance/exit of a building, a meeting place, or a representative of a group reserving the space, and making the attendant/user a person who actually uses the building or meeting place, the guard or the like can manage the attendant/user with regard to time, place and identity even without directly managing the authentication information management system 100 and the authentication system 110.

Subsequently, a further embodiment will be explained by way of an example in which the invention is applied to a booking system/security system of a common meeting room used for general purposes. In the following example, the invention is applied to a meeting room presenting service, in which a person wishing to reserve use of a meeting room applies to reserve the meeting room through a network and exercises entrance control when persons (participants) having authority for entrance enter and leave the meeting room.

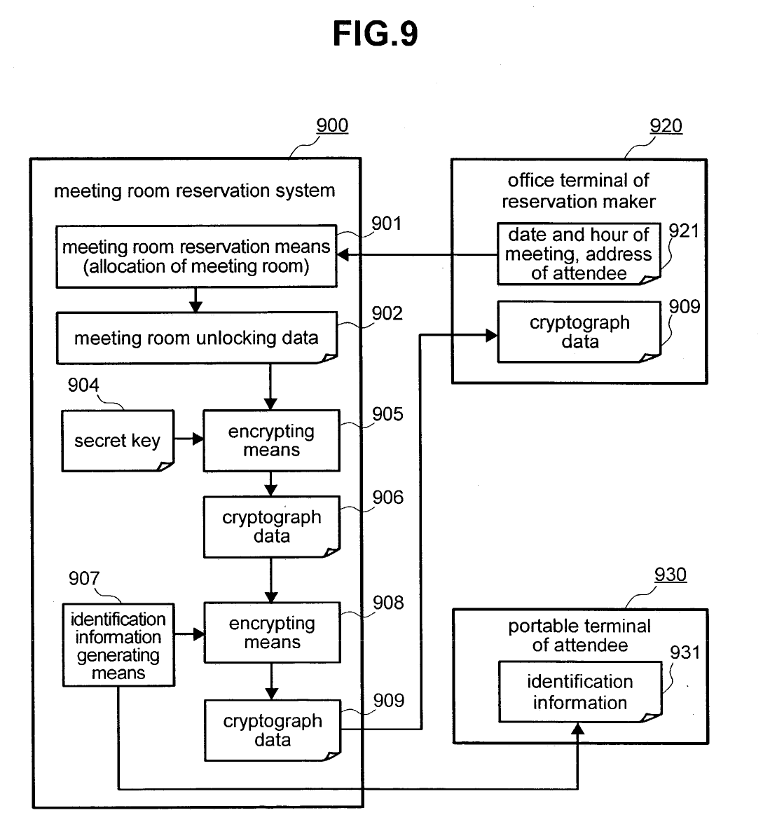

FIG. 9 is a view showing an embodiment, in which the invention is applied to a meeting room subscribing system. The meeting room subscribing system 900 corresponds to the authentication information management system 100, an office terminal of reservation maker 900 corresponds to the manager system 120, and a portable terminal of attendee 930 corresponds to the user system 130, these elements having the same functions as those described above.

When a person wishing to reserve use of a meeting room applies to reserve a meeting room through an office terminal 920 of the reservation maker specifying the date and hour of the meeting and the attendees' addresses 921, the meeting room reservation system 900 uses a meeting room reservation means 901 performing the functions of the data management unit 201 and the data generation unit 202 to allot a meeting room, and forms meeting room unlocking data 902. A first cryptographing means 905 uses a secret key 904 to make the meeting room unlocking data 902 into first cryptograph data 906, and further a second cryptographing means 908 uses identification information 931 generated by an identification information generating means 907 to make the meeting room unlocking data second cryptograph data 909. The second cryptograph data 909 is forwarded to an office terminal 920 of the reservation maker, and the identification information 931 is forwarded to the portable terminal of attendee 930 at the address forwarded from the office terminal of reservation maker 920. Here, the cryptographing processing performed by the cryptographing means 905 is effective in preventing hacking of the whole system, improving security, and preventing falsification. That is, cryptographic protection can be strengthened by performing the cryptographing processing of meeting room unlocking data two times. At this time, the cryptograph processing performed by the first cryptographing means 905 provides strong cryptographic protection using a secret key system for improvement of system security, and the cryptographing processing performed by the second cryptographing means 908 provides weaker protection using a common key system for the purpose of authentication of participants, the purposes of encoding thus being respectively accomplished by appropriate means. More specifically, while meeting room unlocking data itself relates to granting authority for entrance, the whole system is not decreased in strength even in the event of adopting a comparatively weak cryptographing processing since a meeting room cannot be used only by providing the identification information owned by a participant, so that load on the system can be reduced because the cryptograph processing can be simplified. For example, it is conceivable that binary data obtained by embedding identification information into data obtained by adding challenge data which is modified on each occasion to meeting room unlocking data including the name of the meeting room and the date and hour of the meeting and then encoded with a secret key, is forwarded to the person reserving use of the meeting room.

In addition, a proper effect is produced even when the first cryptographing means 905 and the second cryptographing means 908 adopt a common algorithm.

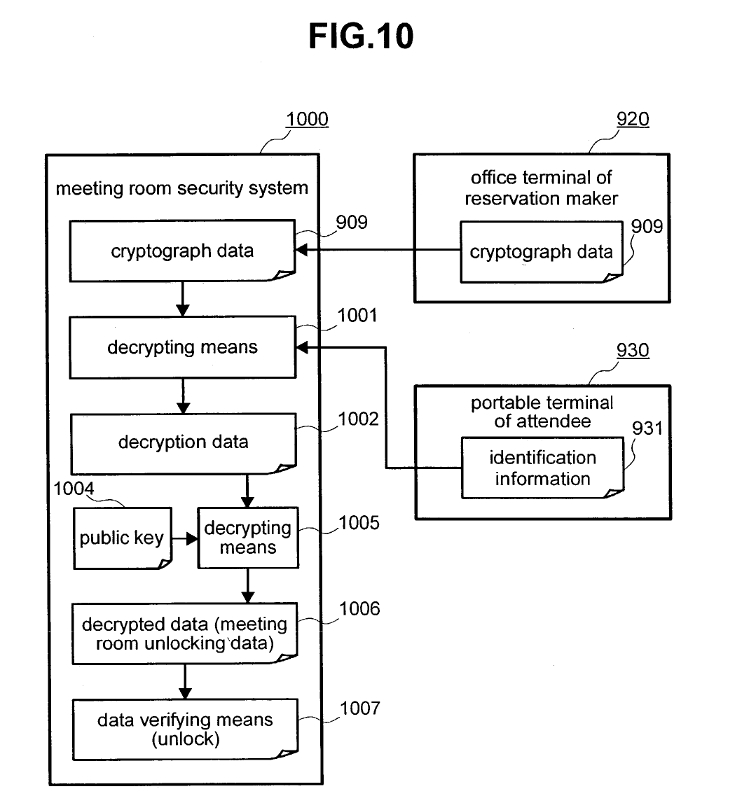

FIG. 10 is a view showing an embodiment in which the invention is applied to a meeting room security system. The meeting room security system 1000 corresponds to the authentication system 110, and has the same function as that described above.

When identification information 931 is received from a portable terminal of an attendee after the cryptograph data 909 from the off ice terminal of reservation maker 920 are received, the meeting room security system 1000 uses first decrypting means 1001 to perform a decrypting processing with the identification information 931 as a decryption key to generate decrypted data 1002. A decryption algorithm reversing the encryption algorithm which is used in the cryptographing means 908 of the meeting room subscribing system 900 is beforehand set up. Further, second decrypting means 1005 uses a public key 1004 which uniquely corresponds to the secret key 904, to make the decryption data 1002 into decryption data (meeting room unlocking data) 1006, and through data verifying means 1007 approval or denial of unlocking (approval and denial of entrance) is made. In this manner, unless a person reserving use of the meeting room forwards that his/her cryptograph data the meeting room security system is not unlocked, so that for example, in the case where a meeting with attendees of various attributes is held using a common meeting room, it is possible to prevent only outsiders from entering the room freely.

Data shown in FIGS. 9 and 10 and managed in the meeting room subscribing system are fundamentally the same as that shown in FIGS. 4 and 5, and it suffices that the space ID 402 corresponds to the number of the meeting room and the time period information 403 corresponds to the date and hour of a meeting.

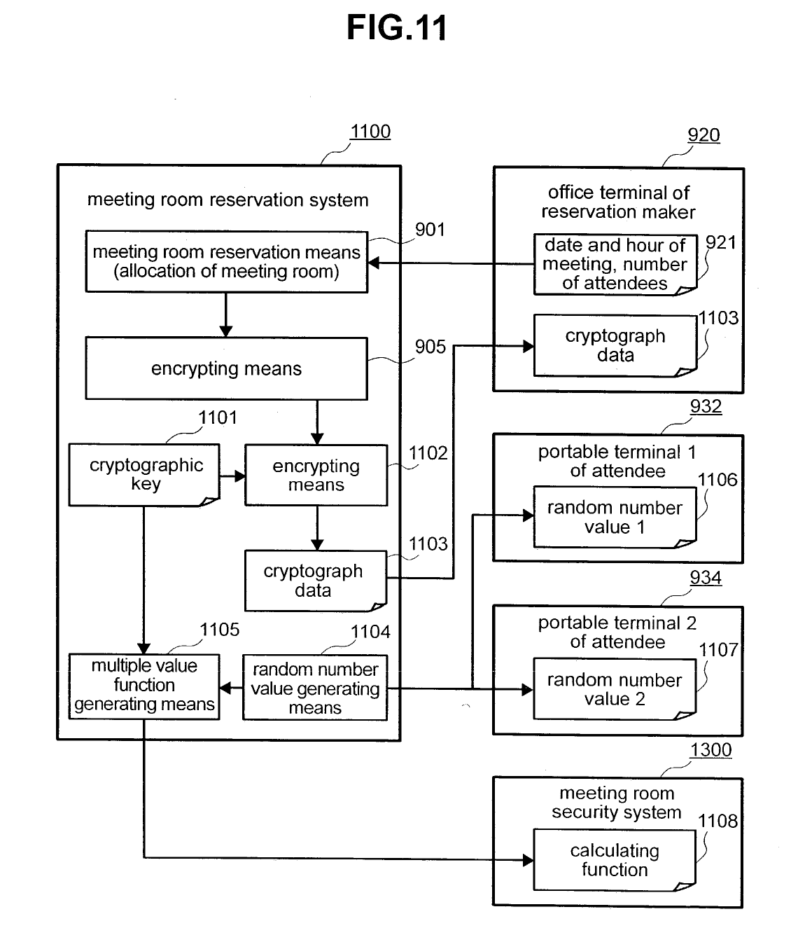

FIG. 11 is a view showing a further embodiment, in which the invention is applied to a meeting room security system. When a person wishing to reserve use of a meeting room applies to reserve a meeting room through a terminal 920 of the reservation maker, the meeting room reserving means. 901 and the cryptographing means 905 perform the same processings as those illustrated in FIG. 9. Cryptographing means 1102 uses a cryptographic key 1101 to create cryptograph data 1103 from cryptograph data generated in the cryptographing means 905. The cryptograph data 1103 is forwarded to the office terminal of reservation maker 920.

Here, data generated by cryptographic key generating means (not shown), or data determined when multiple value function generating means 1105 generates a multiple value function can be used for the cryptographic key 1101. In the case where the cryptographic key 1101 is created by the cryptographic key generating means, random number values (identification information) generated by random number value generating means 1104 as shown in FIG. 11 are used as parameters when a multiple value function is generated by the multiple value function generating means 1105. The multiple value function generated by the multiple value function generating means 1105 is forwarded as a calculating function 1108 to a meeting room security system 1300, and respective random number values 1106, 1107 generated by the random number value generating means 1104 are forwarded as identification information to portable terminals of attendees 932, 934. Also, in the case where the multiple value function generating means 1105 determines a multiple value function and their common identical solution using random number values (identification information) generated by the random number value generating means 1104, the common identical solution is made the cryptographic key 1101 to be used in a decrypting processing by the cryptographing means 1102. The multiple value function generating means 1105 may be integrated with the random number value generating means 1104 to determine both random number values and the cryptographic key 1101 using their connection with the multiple value function.

In the embodiment, respective attendees use individual identification information whereby it becomes easy to specify attendees at the time of management of entrance/exit. Also, management is possible in which identification information which has been once used in judgment of propriety of an attendant/user is made invalid so as to reject a person who attempts entrance/use with the same identification number and the same identification information is made valid again after the an attendant/user leaves.

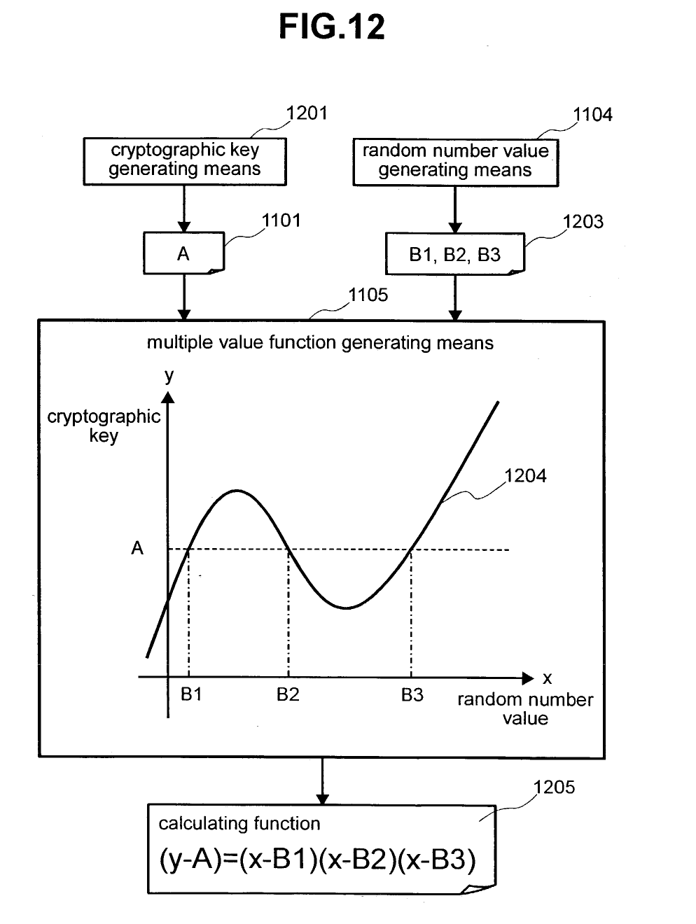

FIG. 12 is a view showing an embodiment of the multiple value function generating means. The embodiment will be explained taking the case where a multiple value function is generated with random number values generated by the random number value generating means 1104 and cryptographic key data generated by the cryptographic key generating means 1201 as parameters.

The random number value generating means 1104 generates random number values 1203, the number of which is the same as that of terminals, with the number of portable terminals of attendees as an input value. For example, in the case where the number of terminals is 3, three values B1, B2, B3 are formed. Meanwhile, the cryptographic key generating means 1201 generates a cryptographic key A (1101). Then, a calculating function 1205 is formed by the multiple value function generating means 1105. At this time, the calculating function 1205 is represented by (y−A)=(x−B1)×(x−B2)×(x−B3).

That is, the function is one in which the value of y is A when a value of x is B1, or B2, or B3, and represented as a cubic curve 1204 on the x-y coordinates. Thereby, different random number values 1203 can be allotted to respective portable terminals of attendees, and the meeting room security system 1300 can perform a correct decrypting processing in the case where a value of B1, or B2, or B3 is input.

In addition, the calculating function 1205 generated by the multiple value function generating means 1105 is not limited to the formula 1 but may be a quaternary or quinary or higher multiple value function.

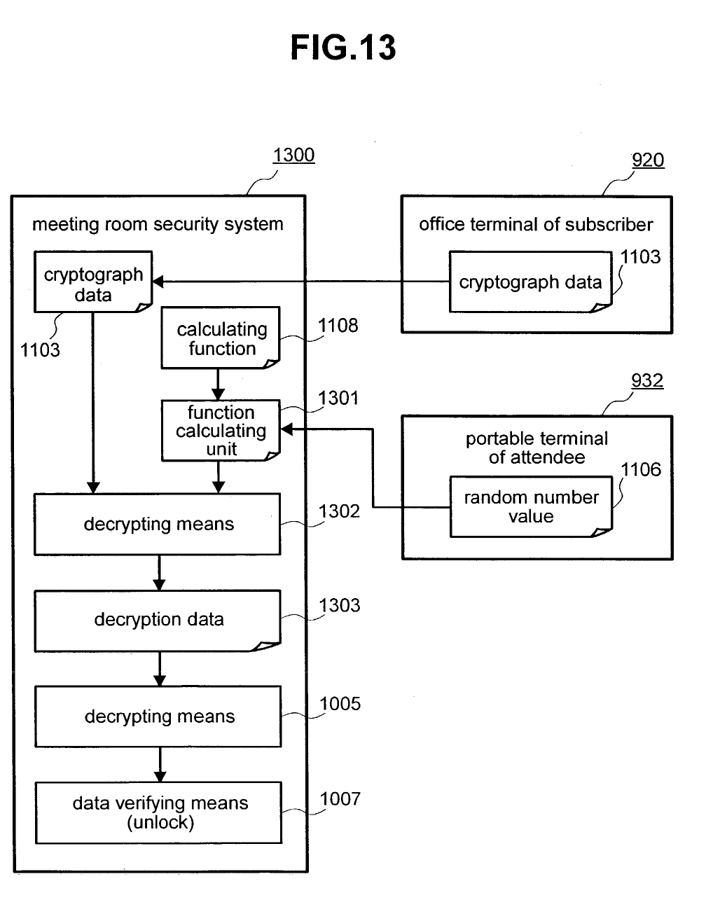

FIG. 13 is a view showing a still further embodiment, in which the invention is applied to a meeting room security system. Receiving cryptograph data 1103 from an office terminal of reservation maker 920 and a random number value (identification information) from a portable terminal of attendee 920, decrypting means 1302 in the meeting room security system 1300 uses a decryption key which is generated by a function calculating unit 1301, to perform a decrypting processing of the cryptograph data 1103 to generate decryption data 1303. Generation of a decryption key by the function calculating unit 1301 is effected by using the calculating function 1108, which is beforehand stored, and a random number value 1106 held by the portable terminal of the attendee to obtain the common identical solution.

The decrypting means 1005 having received decryption data 1303, and the data verifying means 1007 perform the same processings as those illustrated in FIG. 10 to verify propriety of an attendance and approval and denial of unlocking (approval and denial of entrance).

While data shown in FIGS. 11 and 13 and managed in the meeting room subscribing system are fundamentally the same as that disclosed in FIGS. 4 and 5, an effect of the embodiment is further improved by managing random number values in connection with attendants.

Generation and processing of identification information with the use of a multiple value function are not limited to a meeting room booking system/security system but can be optionally applied to other embodiments, and the above embodiments can be suitably modified and combined within a scope not departing from the gist of the invention.

As described above, it is possible according to the embodiment to suitably and flexibly provide verification suited to the attendants/users and situation of entrance/use. Also, it is possible to provide a technique of entrance management taking into consideration that a person provided with a given space manages entrance/exit of persons there. Also, it is possible to provide a technique of management of entrance/exit in which a person who has reserved a common meeting room can suitably and flexibly control entrance/exit. Also, it is possible to provide a common space which is used by various persons with the security required for maintenance and management.

1. An authentication method in an authentication system for judging propriety of a person seeking attendance in a given space, making use of identification information which is issued to a person having authority to grant entrance into the space, the authentication system executing the steps of:
receiving identification/authentication information, issued to a manager of the space and storing the identification/authentication information in storage means,
receiving the identification information from a person attending the space and judging whether identification/authentication information corresponding to the identification information is stored in the storage means, and
judging propriety of the attendance using identification/authentication information stored in the storage means and the identification information in the case where identification/authentication information stored in the storage means is present.

2. The authentication method according to claim 1, wherein the identification/authentication information is cryptograph data generated with a predetermined encryption algorithm, and the identification information is a cryptographic key used when the cryptograph data are generated.

3. A method of managing entrance making use of an authentication information management system for issuing authority for entrance into a given space and an authentication system for approving or denying entrance of a person into the space, comprising the steps of:
causing the authentication information management system to receive the date and hour at which the space is to be used and information on the person or persons having authority to grant entrance into the space on that date and hour from the person who manages the space, to generate first information and second information, which are related to each other by a predetermined encryption algorithm,
causing the authentication information management system to forward the first information to the person who manages the space and the second information to the person or persons having authority to grant entrance into the space,
causing the authentication system to receive the first information from the person who manages the space, to store the first information in storage means owned by the authentication system,
causing the authentication system to receive the second information from a person or persons having authority to grant entrance into the space, and judge whether first information corresponding to the second information is stored in the storage means, and
causing the authentication system to verify validity of the first information in the case where first information is stored in the storage means, and to approve or deny entrance of an attendee using the first information, the second information and a decryption algorithm corresponding to the predetermined encryption algorithm in the case where the first information is valid.

4. The method according to claim 3, comprising further steps of:
causing storage means of the authentication information management system to keep second information generated by the authentication information management system,
collating the second information kept by the storage means with second information which is received from the attendee by the authentication system and then sent to the storage means, and
performing fee charging processing according to results of the collation.

5. The method according to claim 3, wherein the generating step comprises receiving the date and hour at which the specified space is to be used and information on the person or persons having authority to grant entrance into the space at that date and hour from the person who manages the space, and then generating first information and second information for that space at that time.

6. An authentication system for judging propriety of a person seeking attendance in a given space making use of that identification information which is issued to the person having authority to grant entrance into the space from the authentication information management system which issues authority to grant entrance into the space, the authentication system comprising a communication unit for receiving the data which the authentication information management system issued to the reservation maker following the application of the person to reserve the space,
a storage unit connected to the communication unit to store the data and processing programs,
an input/output unit to receive the identification information from an attendee wishing to enter into the space, and
a control unit connected to the communication unit, storage unit and the input/output unit which judges according to the processing programs whether data corresponding to the identification information is stored in the storage unit, whether data is valid in the case where the data is present, and whether the person seeking attendance has propriety using this data and the identification information in the case where the data is valid, to permit entrance of the proper persons.

7. The authentication system according to claim 6, wherein in the judgment of propriety the control unit judges attendance not to be proper in the case where the corresponding data is absent, and/or in the case where the corresponding data is not valid.

8. The authentication system according to claim 6, wherein the identification/authentication information is cryptograph data generated with a predetermined encryption algorithm, and the identification information is the cryptographic key used when the cryptograph data are generated.

9. A meeting room security system connected through a network to a meeting room reservation system, which receives a reservation for use of a meeting room and manages use of a meeting room, comprising
a communication unit connected to the network so that a person reserving the meeting room from the meeting room subscribing system receives a second cryptograph value which is created connecting a user ID allotted to an attendee of the meeting with a first cryptograph value which is created by using a secret key to cryptograph information specifying a meeting,
an input/output unit to receive a user ID, which identifies an attendee of the meeting, from the attendee,
a storage unit to store processing programs, and
a control unit connected to the communication unit, input/output unit and the storage unit and using the processing programs to confirm propriety of an attendee of the meeting using the second cryptograph value, the user ID, and a public key corresponding to the secret key, and output information permitting entrance to proper persons.

10. The meeting room security system according to claim 9, wherein information specifying the meeting is the date and hour of the meeting, and
the control unit judges propriety of an attendee of the meeting on the basis of whether the decrypted date and hour of the meeting agree with the present date and hour.

11. The meeting room security system according to claim 9, wherein the meeting room reservation system uses as a user ID each of plural values having the-same solution in a multiple value function, and each user ID is allotted to each user.

12. The meeting room security system according to claim 11, wherein the control unit manages entrance of individual attendees with the use of the user ID.

13. The meeting room security system according to claim 9, wherein the control unit confirms propriety of an attendee of the meeting by extracting from the storage unit that second cryptograph value which is valid at a point of time when a user ID is received from an attendee of the meeting, and using the extracted second cryptograph value to judge validity of the user ID.
